(19) United States
(12) Patent Application Publication
(10) Pub. No.: US 2021/0061722 A1
(43) Pub. Date: Mar. 4, 2021

(54) INFILTRATION OF POROUS STRUCTURES WITH PARTICLES

(71) Applicant: William Carty, Alfred Station, NY (US)

(72) Inventor: William Carty, Alfred Station, NY (US)

(21) Appl. No.: 17/012,214

(22) Filed: Sep. 4, 2020

Related U.S. Application Data
(60) Provisional application No. 62/895,731, filed on Sep. 4, 2019.

(51) Int. Cl. C04B 41/50; C04B 41/45; C04B 35/52

(52) U.S. Cl. CPC C04B 41/5035; C04B 35/522; C04B 41/456

(57) ABSTRACT

A method of making a particulate infiltrated porous body, including the steps of preparing a suspension of particles of a first composition in a liquid medium, immersing a porous body of a second composition in the suspension, infiltrating the porous body with particles of the first composition with the suspension to yield an infiltrated body, and selectively removing the liquid medium from the infiltrated body while leaving behind the particles of the first composition to yield a particulate-infused body. The porous body of the second composition is not wet by the liquid medium.

### CROSS-REFERENCE TO RELATED APPLICATIONS

This application claims priority to co-pending U.S. Provisional Patent Application Ser. No. 62,895,731, filed Sep. 4, 2019.

### BACKGROUND

The incorporation of particles into a pore network is a challenging problem with wide applicability. A broad spectrum of commercial products could benefit from the ability to form particle coatings on pore walls, such as heterogeneous catalyst, filtration systems and membranes, the filling of pore structures to facilitate evacuation for vacuum applicable systems, the fabrication of ceramic matrix composites and carbon-carbon composites, introduction of particulate dopants into sintering systems, introduction of phosphorescent particles into porous glass compacts, and the placement of electrically conducting pore coatings within an otherwise insulating system. Examples of where particle incorporation is not desired are filtration systems, casting molds (such as gypsum molds for ceramic forming processes), and membrane applications on the surface of a filtration substrate. Historically, the incorporation of particles in a pore network has been only marginally successful. In systems in which the goal is the fill the open space, multiple infiltration events are necessary and even with multiple infiltration cycles, the result is a filled outer surface region with voids remaining in the center.

Thus, there remains a need for a method of incorporating solid particles into a porous network. The present novel technology addresses this need.

### DESCRIPTION OF THE DRAWINGS

FIG. 1 is a photomicrograph illustrating the infusion of porous graphite with colloidal silica particles from an aqueous solution.

FIG. 2A is a photomicrograph illustrating a porous carbon body infused with particulate colloidal silica under 100 PSI.

FIG. 2B is a photomicrograph illustrating a porous carbon body infused with particulate colloidal silica under 3000 PSI.

FIG. 3A is a photomicrograph illustrating a particulate colloidal silica coating a graphite pore wall one centimeter from the surface.

FIG. 3B is a photomicrograph illustrating a particulate colloidal silica coating a graphite pore wall eleven centimeters from the surface.

### DETAILED DESCRIPTION

For the purposes of promoting an understanding of the principles of the invention and presenting its currently understood best mode of operation, reference will now be made to the embodiments illustrated in the drawings. It will nevertheless be understood that no limitations of the scope of the invention is intended by the specific language used to describe the invention, with such alterations and further modifications in the illustrated device and such further applications of the principles of the invention as illustrated therein being contemplated as would normally occur to one ordinarily skilled in the art

The marginally successful infiltration processes known in the art are all based on the same recurring theme, that of the use of a suspension medium that is wetting. With a suspension that wets the substrate, surface tension results in capillary action that pulls the fluid into the pore network. The common current process is a sequential series of steps that usually starts with pulling a vacuum, then introducing the suspension of particles, usually ceramic particles, and then applying pressure to force the suspension into the pore structure with the hope of pushing ceramic particles into the pore structure. This route is rarely, if ever, successful, generating, at best, particles in the pores close to the surface with extremely limited depth penetration. Interestingly, even particles that are sometimes ten times smaller than the pore diameter do not become incorporated into the pores.

The novel technology presented here teaches that a non-wetting suspension medium efficiently and uniformly incorporate particles into a porous network. This means that the suspension medium does not wet the porous substrate. The substrate is generally a ceramic material that has either been partially sintered to leave a continuous open-pore network, or a system with an intentionally generated open pore structure. Other potential applications include sintered metal substrates or a porous polymer or plastic materials. If the suspension medium is non-wetting, the suspension medium is not pulled into the pore network by capillary action.

To force the non-wetting suspension medium into the pore network, pressure is applied to overcome the resistive surface tension forces, similar to the pore infiltration with mercury in Hg-porosimetry, wherein mercury, a non-wetting fluid for a wide range of materials, is forced under pressure into the pore structure. As the pore size decreases the amount of pressure necessary to penetrate the pores increases. A porosimeter measures the volume of Hg intrusion at a given pore size and the data compiled to generate a pore-size distribution.

There are two approaches for this process: (1) working with a substrate in which the pores are filled with gas, usually air; or (2) working with a system in which the gas has been removed from the pore structure usually by the application of a vacuum. Ideally a sintered porous ceramic substrate is used. If the desire is to fill the only the pore structure on the exterior of the ceramic compact, then the sintered compact is submerged in the particle suspension without first evacuating the air from the pore structure. Because the suspension medium is non-wetting, the suspension remains on the exterior of the compact. When pressure is applied the suspension medium, with the incorporated particles, is forced into the pore structure displacing the gas in the pores into the center of the compact. The forcing of a non-wetting fluid into a pore structure under pressure constitutes bulk flow and particles move with the fluid to fill the pore structure. The movement of the suspension into the pore structure compresses the gas into a bubble in the middle of the substrate. The maximum penetration depth is essentially dictated by the balance of pressure within the bubble as it matches the externally applied pressure. The pressure dictates the depth of penetration. When the pressure is removed the bubble expands forcing the suspension medium back out of the pore network leaving the particles behind.

If the porous substrate is evacuated prior to its introduction into the suspension, the application of pressure will entirely fill the porous substrate or compact and after the pressure stage, the liquid may be removed by evaporation, such as with a dryer. Upon the drying of the compact and/or the removal of the suspension medium, the particles remain in the porous substrate coating the walls of the pores, and otherwise at least partially filling the pores. Typically, the particles are homogeneously distributed throughout the substrate body.

The selection of the suspension medium is typically based on the non-wetting characteristics for the substrate in question. In ideal cases, the suspension medium can also be selected to maximize the Hamaker Constant and thus maximize the van der Waals' attractive force between the particle and the substrate. In a typical example, a suspension medium increases the attractive potential between the two surfaces causing agglomeration of the particles on the pore walls. If the material used to coat the surface is similar to the pore wall surface there is a natural attractive force that will agglomerate the particles on the pore walls.

Using this approach, namely the use of a non-wetting suspension medium to incorporate particles into a porous ceramic body, virtually any particles may be introduced into any porous substrate or system, assuming that such a non-wetting fluid can be identified. Suspension stability may play a role as particles may form agglomerates larger than the pore channels, thus blocking fluid flow further into the substrate through at least that particular channel.

In addition, the suspension medium could be a ceramic precursor, such as an organometallic polymer, phenolic resin, and the like. With these suspensions, the particles could potentially act as seeds to facilitate the formation of a second phase in the pore structure. It would also be feasible to use a suspension of more than one particle, such as alumina suspended in colloidal silica, to provide the reactants to form another crystalline compound, such as mullite in this case, by a subsequent heat treatment. If glass formers were used, or frit particles, the pore structure could be filled with glass upon heat treatment after infiltration.

### Examples

To demonstrate proof-of-concept, several examples are presented. In spite of preconceived ‘common knowledge’, gypsum molds used in the slip casting of aqueous suspensions of ceramic particles do not result in particles filling the pore structure. An aqueous medium wets gypsum well, and as a result, no particles are incorporated into the pore structure.

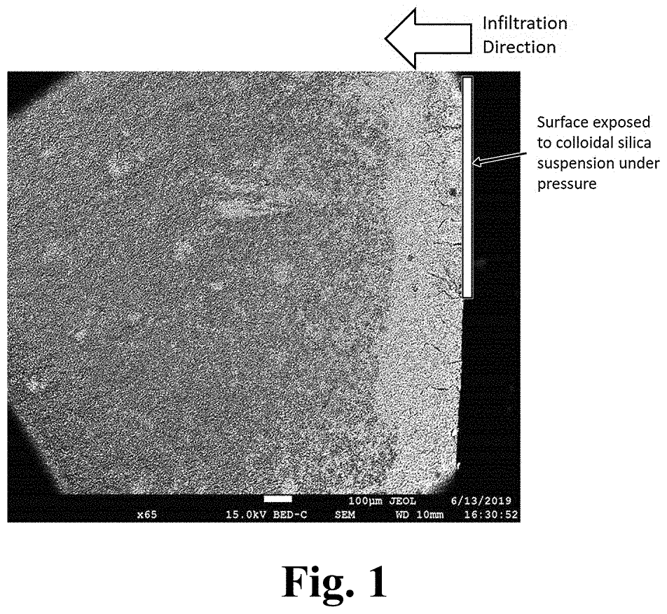

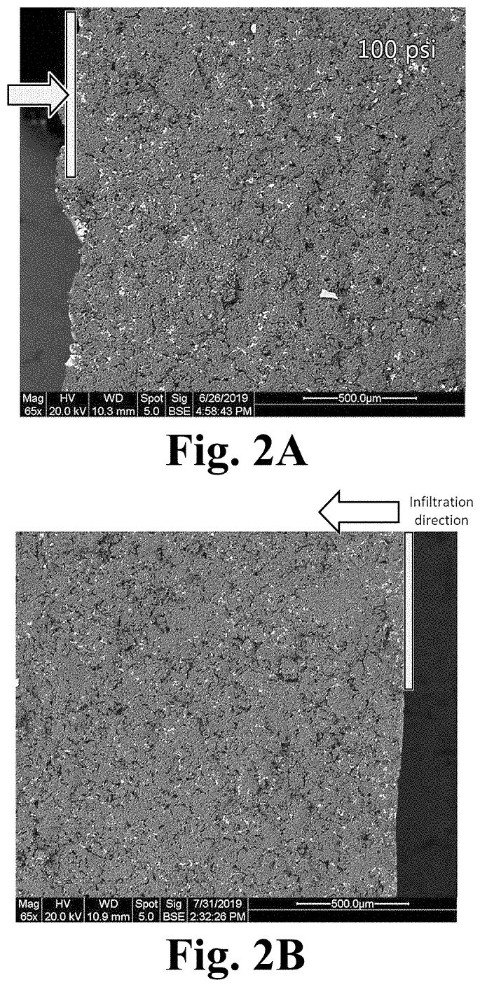

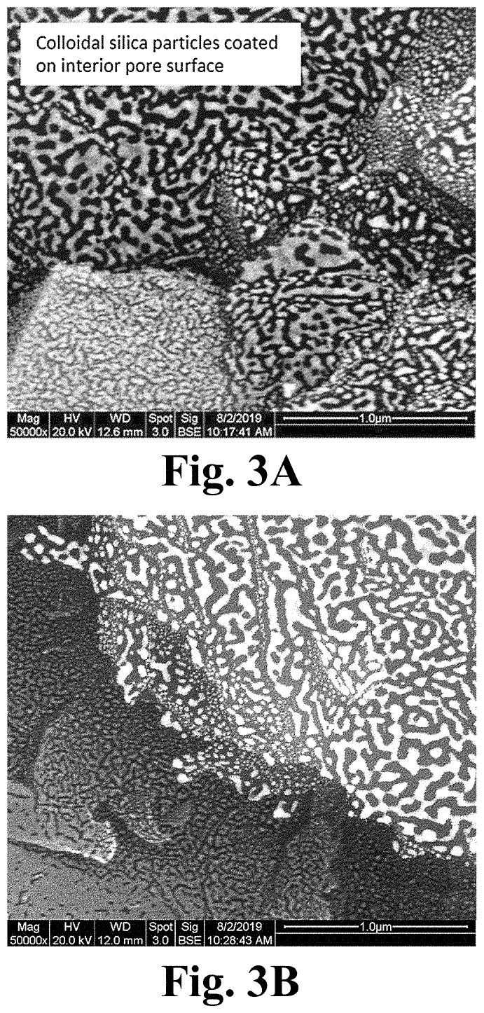

The second case is the incorporation of colloidal silica, from an aqueous suspension, in the pore structure of sintering graphite. The two approaches were exercised: the porous body was introduced into the colloidal silica suspension with no prior vacuum treatment to remove air from the porous body, and with evacuation prior to the introduction of the colloidal silica suspension. FIGS. 1 and 2 illustrate that when the pore structure is filled with air, the particle intrusion distance is approximately 300 microns of dense pore filling, followed by approximately 400 microns of partial pore filling. The second case is when the substrate is evacuated prior to introduction into the colloidal silica suspension and then subsequently submerged in the colloidal silica suspension, the particles are shown to be uniformly distributed through the entire porous structure. On closer inspection (FIG. 3) silica particles are shown to uniformly coat the pore walls in a fracture surface.

Particles can be incorporated into a porous substrate if the suspension medium is non-wetting of the substrate. A non-wetting fluid will require that pressure must be used to force the suspension into the pore structure. If the porous compact is not evacuated prior to the introduction of the suspension, the application of pressure to force the suspension into the porous substrate to the depth dictated by the pressure applied and the corresponding bubble consolidated in the center of the porous compact. If the substrate is evacuated prior to the introduction of the suspension, the particles can be uniformly distributed through the entire porous compact.

This novel technology represents an unexpected deviation from conventional theory and understanding. All currently known coating and particulate infiltration technologies ignore the wetting characteristic of the suspension medium. In fact, most currently employed coating/particulate infiltration technologies prefer or require the suspension medium to wet the substrate material so that a pressure environment is unnecessary.

The novel technology discussed and claimed herein may be used to produce tailored composite materials for, among other things, catalyst supports, filling of pore channels in graphite, coating pore walls for electrical conduction, introduction of phosphors in sintered glass compacts, introduction of particulate dopants for sintering, carbon-carbon and ceramic matrix composite fabrication, coating of filtration materials, oxidation protective coatings for porous metals, incorporation of controlled amounts of second phase, and the like.

If the particles in suspension are repelled from the pore walls, likely because a negative Hamaker Constant, coating of the pore walls with particles will likely be limited. This is the only envisioned situation where this technology may not work as robustly, although it will likely perform substantially better than if the suspension medium were a wetting one.

In operation, a particulate infiltrated porous body may be produced by preparing a suspension of particles of a first composition in a liquid medium, and then immersing a porous body of a second composition in the suspension. Such immersion has the effect of infiltrating the porous body with particles of the first composition to yield an infiltrated body. Once the particles have infiltrated the body, the liquid medium is selectively removed from the infiltrated body to leave behind the particles of the first composition to yield a particulate-infused body. In other words, the pore network within the matrix material defining the porous body or substrate is filled with the particulate suspension and then the liquid suspension medium is removed or ‘dried’ from the pores to leave particles distributed in the pore network. The porous body is not wet by the liquid medium. The porous body may first be evacuated, and the liquid suspension is typically urged into the porous body through an application of pressure.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. A method of making a particulate infiltrated porous body, comprising:
a) preparing a suspension of particles of a first composition in a liquid medium;
b) immersing a porous body of a second composition in the suspension;
c) infiltrating the porous body with particles of the first composition with the suspension to yield an infiltrated body;
d) selectively removing the liquid medium from the infiltrated body while leaving behind the particles of the first composition to yield a particulate-infused body;
wherein the porous body of the second composition is not wet by the liquid medium; and
wherein during step c) the suspension is pressurized.

2. The method of claim 1 and further comprising:
e) before b), evacuating the porous body.

3. The method of claim 1 and further comprising:
f) calcining the particulate infused body.

4. The method of claim 1 wherein the particles are vitreous.

5. The method of claim 1 wherein the suspension includes particles of a third composition.

6. The method of claim 5 and further comprising:
g) calcining the particulate infused body to react particles of the first composition with particles of the third composition to yield particles of a fourth composition.

7. The method of claim 1 wherein the particulate-infused body has a core portion substantially free of particles.

8. The method of claim 1 wherein particles are homogeneously distributed throughout the particulate-infused body.

9. A method of infusing particles into a porous substrate, comprising:
h) preparing a suspension of first composition particles in a liquid medium;
i) infiltrating a second composition porous substrate defining a matrix material and a pore network therein with the suspension to yield an infiltrated body;
j) removing the liquid medium from the pore network to leave first particles composition distributed throughout the pore network to yield a particulate-infused body;
wherein the second composition porous substrate is not wet by the liquid medium;
wherein during step i), the suspension is urged into the pore network under pressure.

10. The method of claim 9 wherein during i), the suspension is urged under pressure into the pore network.

11. The method of claim 9 and further comprising:
k) before i), suspending third composition particles in the liquid medium.

12. The method of claim 9 and further comprising:
l) before i), evacuating the substrate.

13. The method of claim 9 wherein the first composition is identical to the second composition.

14. A method of distributing particles into a pore network in a porous body, comprising:
m) preparing a suspension of particles in a liquid medium;
n) infiltrating a pore network in a porous body with the suspension to yield a composite body;
o) removing the liquid medium from the pore network;
wherein the second composition porous substrate is not wet by the liquid medium;

15. The method of claim 14 and further comprising:
p) before m), evacuating the porous body.

16. The method of claim 14 and further comprising:
q) calcining the particulate infused body.

17. The method of claim 1 wherein the suspension includes particles of two different compositions.

18. The method of claim 5 and further comprising:
r) calcining the particulate infused body to react particles of the first composition with particles of the third composition to yield particles of a fourth composition.

19. The method of claim 1 wherein the particulate-infused body has a core portion substantially free of particles.

20. The method of claim 1 wherein particles are homogeneously distributed throughout the particulate-infused body.
wherein during step i), the suspension is urged into the pore network under pressure.
